(19) United States
(12) Patent Application Publication
(10) Pub. No.: US 2007/0156627 A1
(43) Pub. Date: Jul. 5, 2007

(54) Method and apparatus for creating and using electronic content bookmarks

(75) Inventor: John P. D'Alicandro, Warminster, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/304,463

(22) Filed: Dec. 15, 2005

(51) Int. Cl. G06F 17/30; G06F 7/00; G06F 17/00

(52) U.S. Cl. 707/1; 707/100; 707/104.1

(57) ABSTRACT

An electronic bookmark that includes certain information that enables a bookmarked portion of a content file to be located, sent to the device that activated the bookmark, and executed, run or rendered by a tool or program running on the device that activated the bookmark. The bookmark identifies a portion of a content file. The bookmark may be transferred electronically without the content file, and the user may use the bookmark to automatically link to the bookmarked portion of the content file and to cause the bookmarked portion to be downloaded or streamed to the device that activated the bookmark.

### TECHNICAL FIELD OF THE INVENTION

The invention relates to electronic content bookmarks. More particularly, the invention relates to a method and apparatus for standardizing electronic bookmarks.

### BACKGROUND OF THE INVENTION

Various types of computer systems allow electronic bookmarks to be created that identify a location of content or an amount of content within a file. However, such systems do not provide the ability to transfer an electronic bookmark without the associated content from one electronic device to another to enable a user to access the content within a file that is specified by the bookmark. Normally, the entire file having the bookmarks embedded in it is transferred. The recipient then opens the file and the bookmarked content is provided to the user (e.g., the bookmarked text is displayed to the user).

One of the disadvantages of the current electronic bookmark technology is that the content is transferred along with the bookmarks. This consumes network bandwidth and local memory in the recipient's device. Another disadvantage is that the type and amount of information that makes up the electronic bookmarks varies from one software program to another. Consequently, different decoding techniques are required for decoding different types of bookmarks, which increases decoder complexity.

A need exists for an electronic bookmarking technique that provides for transferring bookmarks without content. A need also exists for a protocol that defines a standard for electronic bookmark such that bookmarks can be created and used in a way that is independent of content type and independent of tools that are used to execute and/or render the content.

### BRIEF DESCRIPTION OF THE DRAWINGS

FIG. 1 illustrates a network diagram that demonstrates creation of a bookmark by a first PC and use of the bookmark by a second PC to access a bookmarked portion of a video file that resides on a media server connected to the Internet.

FIG. 2 illustrates an electronic bookmark.

FIG. 3 illustrates a network diagram that demonstrates creation of a bookmark by a first wireless device and use of the bookmark by a second wireless device to access a bookmarked portion of an audio file or text file, which reside on respective servers connected to the Internet.

FIG. 4 illustrates an electronic bookmark.

FIG. 5 illustrates a pictorial representation of a scenario in which a portion of a movie is bookmarked and the bookmark is distributed to customers to enable them to access the bookmarked portion of the movie.

FIG. 6 illustrates a flowchart that demonstrates a method for activating a bookmark thereby causing the bookmarked portion of a file to be sent to the terminal device that activated the bookmark.

FIG. 7 illustrates a flowchart that demonstrates a method of the invention in accordance with another embodiment for activating a bookmark thereby causing the bookmarked portion of a file to be sent to the terminal device that activated the bookmark.

FIG. 8 illustrates an apparatus for constructing the electronic bookmark.

FIG. 9 illustrates an apparatus for activating and using the electronic bookmark.

FIG. 10 illustrates a graphical user interface (GUI) for creating and/or editing an electronic bookmark.

FIG. 11 illustrates a flowchart of a method for creating and/or editing an electronic bookmark.

### DETAILED DESCRIPTION OF THE PREFERRED EMBODIMENT

The bookmark protocol standard defines an electronic bookmark as including certain information that enables the portion of the bookmarked content file to be located, sent to the device that activated the bookmark, and executed by a tool or program running on the device that activated the bookmark. The bookmark may be transferred electronically without the content file, and the user may use the bookmark to automatically cause the bookmarked portion of the content file to be downloaded or streamed to the device that activated the bookmark.

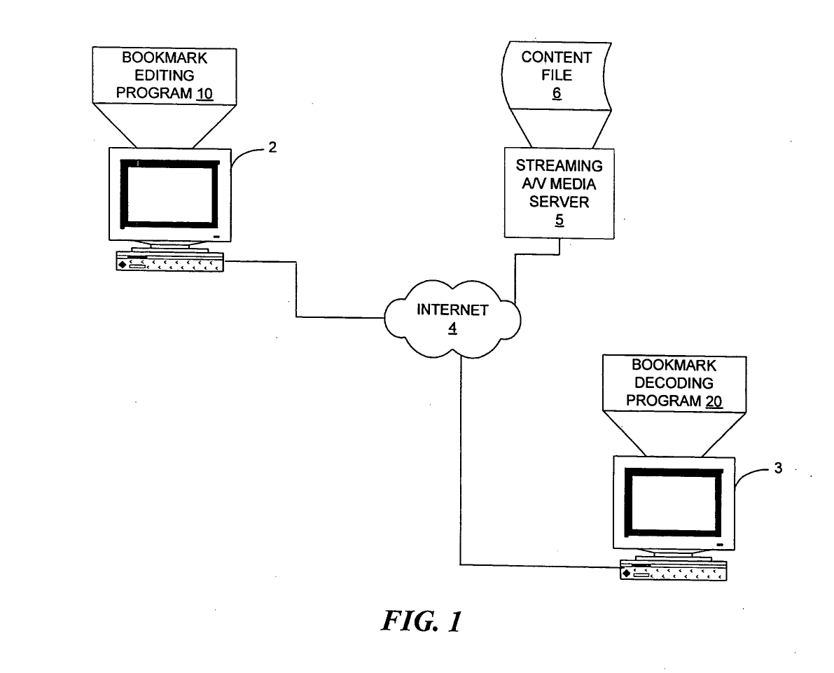

FIG. 1 illustrates a pictorial diagram of an example of a network over which an electronic bookmark is transferred from a sender's personal computer (PC) 2 to a recipient's PC 3. In accordance with this example, the sender uses a bookmark editing program 10 to create the bookmark, and then embeds the bookmark in an email message or attaches the bookmark as an attachment to the email message. The email message with the attached or embedded bookmark is then sent via the Internet 4 to the recipient's PC 3. The content file with which the bookmark is associated need not be included in the email message. Rather, the content file resides on a media server 5.

When the recipient opens the email message, the bookmark appears as a link. When the recipient causes the bookmark to be executed by the recipient's computer 3 by “clicking” (e.g., with a mouse) on the bookmark, a bookmark decoding program 20 residing on the recipient's PC 3 is executed by the recipient's PC 3. In this example, the content file is an audio/video (A/V) file (e.g., a movie) 6 residing on a streaming A/V media server 5. The bookmark decoding program 20 decodes the bookmark and uses the decoded bookmark information to automatically retrieve the bookmarked portion of the content file 6. The bookmarked portion of the file may be, for example, a twenty-second clip. Therefore, the bookmark identifies the beginning of the bookmarked portion of the A/V file 6 and the end of the bookmarked portion of the A/V file 6.

In this example, the start and end of the bookmarked portion are defined in terms of time from the beginning of the A/V file. For example, if the bookmarked portion is identified as beginning one hour and fifteen minutes into the movie, and the bookmarked portion is three minutes in length (i.e., Δ=3 minutes), the end of the bookmarked portion is identified as being one hour and eighteen minutes into the movie, i.e., the start time of the bookmarked portion plus Δ.

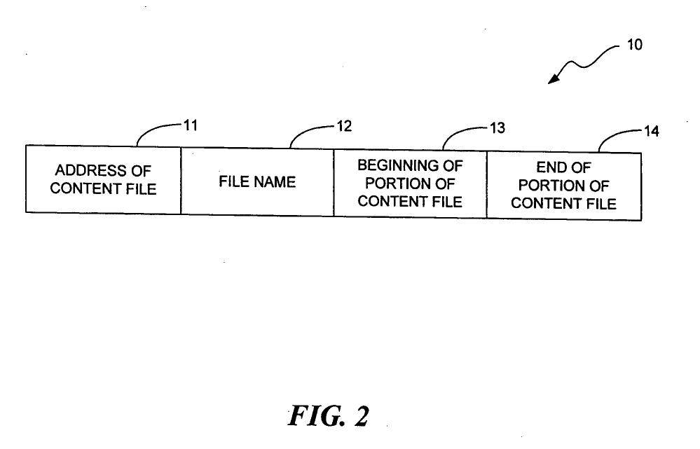

FIG. 2 illustrates an example of the electronic bookmark 10. The bookmark 10 includes at least information that identifies the address of the content file 11, the content file name 12, the start of the portion of the file that is bookmarked 13, and the end of the portion of the file that is bookmarked 13. The content file may reside at a location that is identified by an Internet Protocol (IP) address, such as an address in a local area network (LAN), a wide area network (WAN), or the Internet. Alternatively, the content file may reside on the sender's PC 2 or locally on the recipient's PC 3. It should also be noted that although it is not necessary for the content file to be transferred along with the bookmark, the content file may be transferred along with the bookmark. As described below in detail with reference to Table 1, the bookmark may, and typically will, include other types of information.

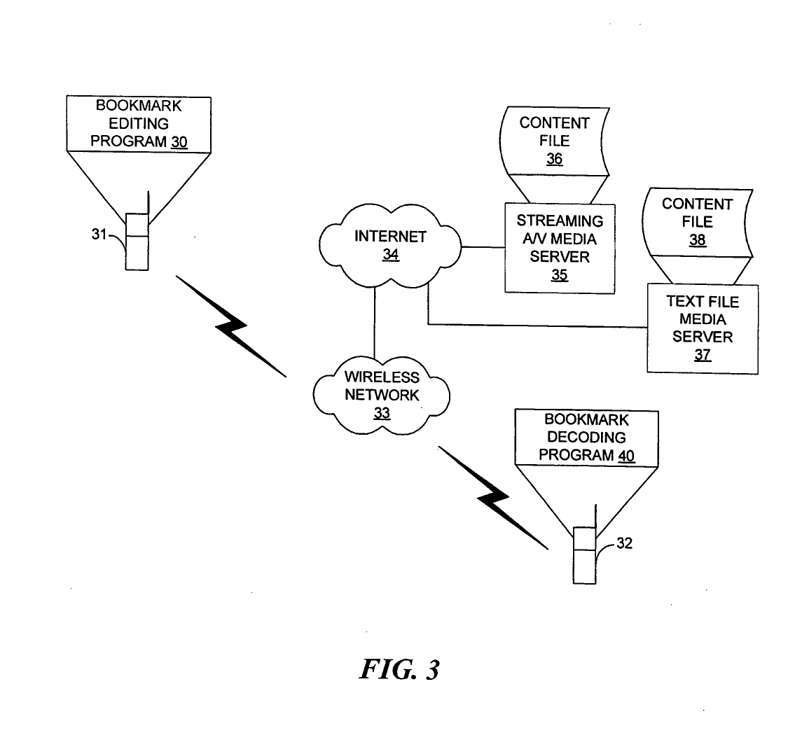

FIG. 3 illustrates a pictorial diagram an exemplary embodiment of a network over which an electronic bookmark is transferred from a sender's wireless telephone 31 to a recipient's wireless telephone 32. In accordance with this example, the sender embeds the electronic bookmark in a text message, an email message, or other form of electronic communication that is sent from the sender's telephone 31 via wireless network 33 to the recipient's wireless telephone 32. The sender's wireless telephone 31 includes a processor (not shown) that executes a bookmark editing program 30 that enables the sender to create the bookmark and embed it in the electronic communication. The recipient's wireless telephone 32 includes a processor (not shown) that executes a bookmark decoding program 40. When the recipient selects the bookmark by, for example, pressing one or more keys on the telephone keypad, the bookmark decoding program 40 decodes the bookmark. When the program 40 decodes the bookmark, it will automatically access the A/V media server 35 via the Internet 34 and retrieve the bookmarked portion of the content file 36.

In the example represented by the diagram shown in FIG. 3, the bookmark provides a link to a streaming audio file 36 stored on the A/V media server 35. The streaming audio file 36 contains a collection of music selections by the same artist. The bookmarked portion of the file 36 corresponds to a particular music selection contained in the collection. Thus, the bookmark marks the start and end location in terms of time into the streaming audio file. The corresponding music selection is streamed to the recipient's telephone 40, which plays the streaming audio selection.

In accordance with another exemplary embodiment, the bookmark provides a link to a text file 38 stored in a text file media server 37. When the recipient selects the bookmark embedded in the text message, the bookmark decoding program 40 decodes the bookmark and accesses the text file media server 37. The bookmark identifies the start and end locations in the text file in terms of the number of bits from the beginning of the text file to the bookmark start location, and from the bookmark start location to the bookmark end location. The bookmarked portion of the text file 38 is then transmitted from the text file media server 35 to the recipient's telephone 32 via the Internet 34 and the wireless network 33.

The examples described above with reference to FIGS. 1 and 3 are intended to demonstrate that the bookmark can be used by any type of user device, including, for example, PCs, wireless telephones, wireless personal digital assistants (PDAs), a cable set top box, a satellite set top box, a residential gateway, etc. The examples described above with reference to FIGS. 1 and 3 are also intended to demonstrate that information of any type may be bookmarked, including, for example, audio files (e.g., music selections), audio/video files (e.g., movies), text files, and image files. The bookmark protocol standardizes the information that is included in the bookmark to enable bookmarks to be used by various types of user devices to access various types of information over various types of networks.

As stated above with reference to FIG. 2, the bookmark includes information that identifies the bookmark start and end locations. The bookmark “start” location preferably is marked as (1) time into the file at play speed, (2) absolute length into the file in bits from the beginning of the file, (3) absolute length into the file in bits from an earlier bookmark in the same file, (4) number of video or audio frames in a stream, or (5) number of images in a slide show. The bookmark location that preferably is given as the delta, Δ, of distance in time, number of bits or number of frames from the bookmark start location. If the bookmark start location is given in terms of an amount of time from the beginning of the file, then the bookmark end location preferably is given as an amount of time from the bookmarked start location. Similarly, if the bookmark start location preferably is given in terms of a number of bits from the beginning of the file, then the bookmark end location is given as a number of bits from the bookmarked start location. Similarly, if the bookmark start location is given in terms of a number of frames from the beginning of the file, then the bookmark end location preferably is given as a number of bits from the bookmarked start location.

The bookmark typically includes information in addition to that shown in FIG. 2. Table 1 illustrates several different types of information that are typically included in the bookmark. The bookmark is typically made up of a plurality of bits, characters or symbols that represent the various types of information that make up the bookmark. XML files contain information that is represented by strings of characters, while broadcast stream technologies represent information in bit strings or symbols. The bookmark protocol enables these various types of information to be represented and processed in a manner that is independent of the data type. Therefore, the term “information” will be used herein to mean “bits”, characters” and/or “symbols”.

The bookmark may include information that identifies (1) a name of the bookmark from the source domain by the owner of the bookmark, (2) the date, or date and time, when the bookmark was created, and (3) the creator of the bookmark. For example, in FIG. 1 the bookmark creator is the sender who uses the bookmark editing program 10 on PC 2 to create the bookmark.

The term “domain”, as that term is used herein, is intended to denote a location within an association or group of physical or logical items that share communications, content controls, and/or rules for access, which uniquely defines whatever holds the associated content file. Thus, the domain of a content file may be defined in terms of, for example, a URL address, a networked directory, a directory mapping, etc. It should also be noted that while a physical or logical address of a device may change, the corresponding domain does not change. For example, the logical address of a wireless PDF may change as it is moved from one location to another, the domain of the PDF does not change, which enables the domain to always be used to locate the PDF, and a content file or another bookmark that resides thereon. Likewise, the logical address of a cellular telephone may change as it is moved from one location to another, but its domain will not change. In all cases, the domain uniquely defines the location of the file such that a search that is performed using the bookmark will locate the exact, specific version of the content file.

The bookmark may include information that identifies the date, or date and time, when the bookmark was last edited. For example, with reference again to FIG. 1, the PC 3 that receives the bookmark may also be programmed to execute the bookmark editing program 20 that would enable the recipient to modify the bookmark. The bookmark may include information that identifies the owner of the last bookmark editing session.

The bookmark may include information that identifies the content file type, e.g., audio, video, photograph, text, etc. The bookmark may include information that identifies the content file source domain, which is the address where the file resides. For example, in FIG. 1, the file type is A/V, and the file source domain is the IP address of the streaming A/V media server 5. The bookmark may include information that identifies (1) the file name assigned to the content by the content owner, (2) the date when the content file was created, (3) the owner who created the content, (4) the date the content was last edited, (4) the owner of the last content edit session, (5) the date and time when the file was last marked with the bookmark, and (6) the location of the content file (e.g., an IP address of a server, a directory location on a hard drive, etc.). One or more of these information fields are used to locate the correct file wherever it resides (e.g., on a media server on the Internet).

The bookmark includes information that identifies (1) the start location of the bookmarked portion of the content file, and (2) the end location of the bookmarked portion of the content file. As stated above, the start of the bookmarked portion of the content file may be identified in terms of (1) hours:minutes:seconds:frame, (2) frame/image/page/count, or (3) length in bits. The end location may be identified as distance from the start bookmark location in terms of (1) hours:minutes:seconds:frame, (2) frame/image/page/count, or (3) length in bits.

### Bookmark File Structure

TABLE 1

| | | |
|---|---|---|
| Entry Name | Description | Size |

BOOKMARK ROOT INFORMATION SECTION

| | |
|---|---|
| Bookmark Name | name given to bookmark from |
| | source domain by owner. |
| Bookmark Created Date | date on which owner created |
| | bookmark |
| Bookmark Creation Owner | original owner of bookmark. |
| | Owner is completely defined as: |
| | Domain |
| | OwnerName |
| Bookmark Last Edited Date | date of last edit of bookmark. |
| | Assists in establishing lineage of |
| | specific bookmark |
| Bookmark Last Edit Owner | owner of last edit session of book- |
| | mark. Owner is completely defined |
| | as: |
| | Domain |
| | OwnerName |

BOOKMARK ASSOCIATED CONTENT INFORMATION
SECTION

| | |
|---|---|
| Content Type | defined as one of the four types of |
| | content files: |
| | Audio |
| | Video |
| | Photo |
| | Text |

Content File Uniqueness Information

| | |
|---|---|
| Content File Source Domain | name of the source domain within |
| | which this file originates. |
| Content Filename | filename given to content from |
| | source domain by owner. |
| Content Creation Date | date on which file was originally |
| | created by owner |
| Content Marked Date | date/time when file was originally |
| | marked with this bookmark |
| Content Creation Owner | owner of the content file. Owner is |
| | completely defined as: |
| | Domain |
| | OwnerName |

Bookmark Content Location Information

| | |
|---|---|
| Content Location Bookmark | Bookmark start location within the |
| Start Mark | source content file. This shall be in |
| | terms of some absolute measure |
| | from the start of the file: |
| | time—hrs:min:sec:frame |
| | frame count |
| | length—in bits |
| Content Location Bookmark | Bookmark end location within the |
| End Mark | source content file. This shall be |
| | in terms of some absolute measure |
| | from the start mark location in the |
| | file: |
| | time—hrs:min:sec:frame |
| | frame count |
| | length—in bits |

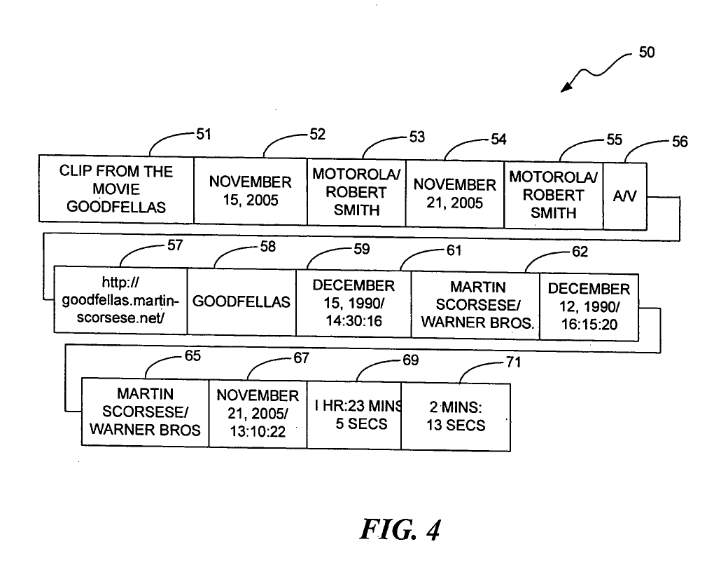

FIG. 4 illustrated an example of an electronic bookmark 50 having the file structure illustrated in Table 1. In this example, the bookmark 50 is created by Robert Smith, an employee of Motorola Corporation and sent to Bill Adams, an employee at ABC Corporation. The bookmark 50 references a portion of an A/V file that resides on a media server that is attached to the Internet. The bookmark name is: CLIP FROM THE MOVIE GOODFELLAS, as indicated by box 51. The bookmark was created on Nov. 15, 2005, as indicated by box 52. The bookmark creation owner's domain is Motorola Corporation and his name is Robert Smith, as indicated by box 53. The bookmark was last edited on Nov. 21, 2005 by the bookmark edit owner, who is also the bookmark creation owner, Robert Smith, as indicated by boxes 54 and 55, respectively.

The content file is of type A/V, as indicated by box 56. The content file source domain is http://goodfellas.martin-scorsese.com, as indicated by box 57. The content file name is “GOODFELLAS”, as indicated by box 58. The content creation date, which typically also includes a time signature, is Dec. 15, 1990, 14:30:16 as indicated by box 59. The content creation domain and owner are Martin Scorsese and Warner Brothers Corporation, respectively, as indicated by box 61. The content was last edited on Dec. 12, 1990 at 16:15:30 by domain/owner Martin Scorsese/Warner Bros, as indicated by boxes 62 and 65, respectively. The content was originally bookmarked with this bookmark on Nov. 21, 2005 at 13:10:22. The bookmark start location is 1 hour, 23 minutes and 5 seconds into the file, as indicated by box 69. The bookmark end location is 2 minutes and 13 seconds from the start location (i.e., Δ=133 seconds), as indicated by box 71.

The bookmark 50 shown in FIG. 4 is received by the intended recipient, Bill Adams at ABC Corporation. When Bill Adams selects the bookmark, the bookmarked portion of the A/V file will automatically be played back on his computer, provided he has been granted access to the file. For example, access to the file may require a subscription to an A/V service. Table 2 below represents additional information that may be included in the bookmark when the bookmark is used in a dynamically-enabled digital rights management (DRM) environment. The bookmark may be structured to include information that defines varying levels of access to be granted to bookmark recipients, and that provides a mechanism for enabling the bookmark recipient to gain access, or to gain a different level of access.

### Bookmark File Structure

TABLE 2
Bookmark Type Information Loop

| | | |
|---|---|---|
| Bookmark Type Count | count of the number of Bookmark types | |
| | supported by this Bookmark. | |
| Bookmark Type | described as one of the following: | |
| | public—may exist without any | |
| | additional lists (in which case this | |
| | bookmark is available to ALL), | |
| | or may exist with an authorization level | |
| | list (similar to allowing “members only” | |
| | without needing a membership list only | |
| | the appropriate credentials). | |
| | private—must have authorization level | |
| | list and authorized user list, which can | |
| | effect authorization levels of content. | |
| | Specifies that “only” these users and | |
| | they must present appropriate | |
| | credentials. | |
| Bookmark Authoriza- | Flag to control appending of authoriza- | Yes/No |
| tion Lists | tion lists of EndUser to this bookmark | |
| | with regard to access of the content | |
| | marked by this bookmark. Authoriza- | |
| | tion lists are to be provided after con- | |
| | tent information section. | |
| Bookmark Associated | Flag to control appending of lists of | Yes/No |
| Linked Lists | EndUsers with ability to access this | |
| | bookmark. Associated Linked Lists are | |
| | to be provided after Authorization Lists. | |

If INCLUDED (marked as YES) Bookmark Authorized EndUser Lists

| | | |
|---|---|---|
| BAL Count | count of the number of authorized | at least |
| | EndUser lists | 1 |

BAL List Loop

| | |
|---|---|
| BAL ListName | name given to list by creator/owner. A |
| | value of 0 means that this level of rights |
| | applies for “all End Users” (and no list |
| | of EndUsers will be supplied). A value |
| | of 0 will defer access rights to those |
| | of the file (to be considered the mini- |
| | mum access level allowed). EndUser |
| | Lists are denoted with filename ex- |
| | tensions *.EUL and that the extension |
| | is not used in the BAL ListName. |
| BAL List Security | descriptor for the type of security used |
| Type | to protect the associated linked list of |
| | EndUser authorized for this bookmark. |
| BAL List Security | information specific for the security |
| Information | of the linked list of EndUsers authorized |
| | for this bookmark. |
| BAL List Source | name of the source domain within |
| Domain | which this BAL list has rights. |
| BAL List Owner | name of owner of this BAL list associ- |
| | ated to this bookmark. Owner is |
| | completely defined as: |
| | Domain |
| | OwnerName |

If INCLUDED(marked as YES) Bookmark Authorized Level List

| | | |
|---|---|---|
| BALL Count | count of the number of authorized rights | at least |
| | available for those EndUsers in the as- | 1 |
| | sociated authorized list as granted by | |
| | the creator/owner | |

BALL List Loop

| | |
|---|---|
| BALL ListName | name given to list by creator/owner. |
| BALL List Source | name of source domain within which |
| Domain | this BALL list has rights as granted by |
| | the creator/owner |
| BALL List Owner | name of the owner of this BALL list |
| | associated to this bookmark. Owner is |
| | completely defined as: |
| | Domain |
| | OwnerName |
| BALL Rights Count | count of the number of rights associated |
| | with this BALL for this Bookmark. |

BALL Rights Loop

| | |
|---|---|
| BALL List Rights | rights to content on domain described |
| | by this “linked list”, as granted by the |
| | creator/owner. This value can be en- |
| | crypted, and if encrypted also will |
| | contain a check-value to both the linked |
| | list and the authorization list. |
| | Authorized Rights include: |
| | read |
| | write |
| | delete |
| | create |
| | edit/append/alter |
| | move |
| | transfer |
| | archive |
| | restore |
| | grant |
| | inherit |
| | full |

Sample of Possible Authorized EndUser List
(NOTE: that BAL List Member Files may be denoted with extension
*.EUL (end user list)).
(NOTE: for security purposes—the filename preferably is not carried
within the file to prevent any “preloading” or “seeding” security
concerns).

| | |
|---|---|
| BAL List Member | count of the number of members |
| List Count | associated with this specific linked list. |

BAL List Member Loop

| | |
|---|---|
| BAL List Member | name of the source domain of the |
| Domain | member of this linked list |
| BAL List Member | name of the EndUser from the listed |
| EndUser Name | Source Domain of this linked list. |

The bookmark may include information that identifies the bookmark type. For example, the bookmark type may be public or private. If the bookmark is public, then the bookmark is available to everyone to use. If the bookmark is private, the recipient of the bookmark must be on one or more authorization level lists that are part of the bookmark or stored in some location that is accessible via the bookmark.

The bookmark may include information that is used as a flag that identifies whether a bookmark authorization list (BAL) is appended to the bookmark. The BAL is a list of users who will be granted access to the bookmarked portion of the content file. If the flag is set, then this indicates that a BAL is appended to the bookmark. Therefore, when a recipient of the bookmark attempts to access bookmarked content, if the flag is set, a determination will be made by the machine that controls access to the content (e.g., a video server) as to whether or not the person attempting to access the file is on the BAL. The BAL will typically contain identifiers that identify users. Identifiers may be, for example, user's names, telephone numbers, email addresses, IP addresses, etc.

The bookmark may include information that is used as a flag to indicate whether or not one or more bookmark associated linked lists (BALLs) are appended to the bookmark. Any BALLs will be appended after the BAL. If the flag is set in the BALL field, this indicates that a BALL is appended after the authorization list. The BALL is a list of end users who will be allowed to use the bookmark itself. The bookmark may include information that identifies the number of BAL and BALLs that are appended to the bookmark. This is referred to herein as the BAL and BALL count, respectively.

The bookmark may include information that identifies the name assigned to the BAL by the creator of the BAL. For example, a value of 0 for this field may indicate that this level of rights applies to all users, and therefore no list will be appended. The BALs may be denoted with filename extensions *.EUL, and that extension will not be used in the BAL name. The bookmark may include information that identifies the BAL list security type. This is a descriptor that describes the type of security that will be used to protect the associated linked list of end users authorized for this bookmark. The bookmark may include information that is used to provide information specific for the security of the linked list of authorized end users.

The bookmark may include information that identifies the name of the source domain within which the end users listed on the BAL have access rights. The bookmark may include information that identifies the domain and owner name of the BAL. The bookmark may include information that identifies the number of authorized rights available for the end users who are listed on the BAL.

The bookmark may include information that identifies the name given to the BALL by the creator of the BALL. The bookmark may include information that identifies the source domain within which users listed on the BALL will have access. The bookmark may include information that identifies the domain and owner of the BALL. The bookmark may include information that identifies the number of rights that are associated with this BALL for this bookmark. This is referred to herein as the BALL count. The bookmark may include information that identifies the rights that users who are listed on the BALL will have access in the BALL domain.

The bookmark may include information that identifies the number of members associated with the BALL, which is referred to herein as the BALL member count. The bookmark may include information that identifies each member of the BALL, and the end users from the listed source domain of the BALL.

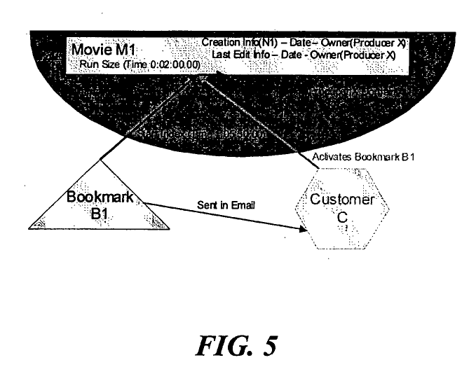

FIG. 5 illustrates a flow diagram that demonstrates the creation, transmission and use of a bookmark that references a portion of a movie. The movie content is represented in FIG. 5 by M1. The bookmark is represented in FIG. 5 by B1. The creation of the content M1 is as follows. Producer X creates movie M1 on date N1 in domain X. Creation of Bookmark B1 for Content M1 is as follows. Producer X decides to use a specific clip from the movie M1 to make an advertisement. The clip starts at time-index 1:05:50.00 (1 hr, 5 min, 50.00 sec) and runs for 120 seconds. The clip is Bookmarked B1. Producer X may provide information about the clip to the public via different media such as, for example, direct mail, in-store advertisements, direct emails, etc.

Customer C receives an email message with the bookmark B1 attached as an attachment. The email message may come from Producer X or from some other entity. Customer C “activates” the attachment by, for example, double-clicking on the attachment with a mouse. Activation of the bookmark causes the bookmark decoding program described above with reference to FIGS. 1 and 3 to be executed, which reads the data contained in the bookmark, and then causes one or more additional programs to be executed, which cause the bookmarked portion of the content file to be retrieved from wherever it resides and played back on Customer C's terminal device (e.g., PC). These additional programs may be, for example, a Windows Media player, Adobe Acrobat,etc.

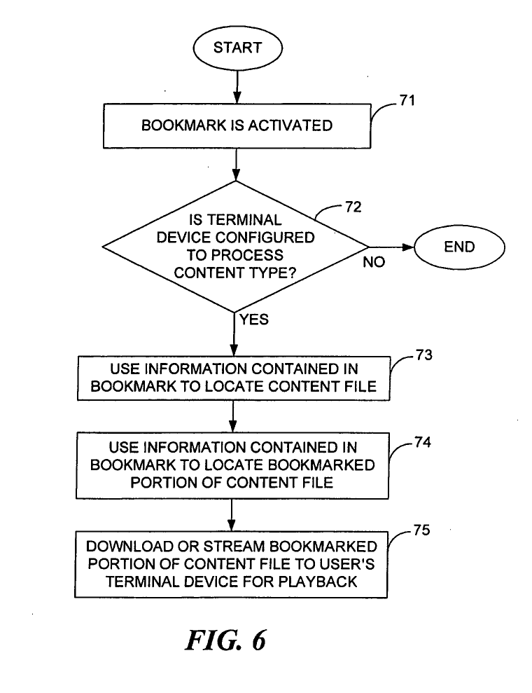

FIG. 6 illustrates a flowchart that demonstrates activation of the bookmark and the processes that occur following activation of the bookmark. When Customer C's terminal device activates the bookmark, as indicated by block 71, the terminal device analyzes the content type identified in the bookmark to determine if it can handle the content type, as indicated by block 72. In the case of video content type, the terminal device will need to have the ability to handle video streams and video file types. The terminal device may also analyze the bookmark filename to verify that the device has hardware, software or firmware to process and/or render the bookmarked file content. If the terminal device is not configured to process the identified content type, the program ends.

If the terminal device is configured to process the identified content type, then the terminal device uses one or more of the following information fields contained in the bookmark (Table 1) to locate the content file: filename, content domain, content creation date, content owner, content last edit date, and content last edit owner. This step is represented in FIG. 6 by block 73. When the device locates the specific bookmarked file, the device scans the content file and locates the content location bookmark start mark. This step is represented in FIG. 6 by block 74. The bookmarked portion of the content file is then downloaded or streamed to the user's terminal device, as indicated by block 75.

There are several parts of the process described above with reference to FIGS. 5 and 6 where alternative processes may take place. The following are examples. It is not necessary for Customer C to specify the software program (e.g., Microsoft Word, Adobe Acrobat) or media player (e.g., Real Player, Quicktime, etc) that is used to process the bookmarked portion of the content file on Customer C's terminal device. Which of these programs or tools is used by Customer C's terminal device is dictated by the design of the bookmark decoding programs described above with reference to FIGS. 1 and 3. Producer X has flexibility in determining what content may be used by bookmarks. For example, Producer X may protect the value of movie M1 by creating a lower-quality SD 4:3 version, M1.2, of the movie M1. Version M1.2 may then be used to create the clip that is referenced by the bookmark. This clip may then be referenced by bookmark B1.2.

These are only a few of the many possibilities of alternatives that are available to the content creator, the bookmark creator and the bookmark user that provide for flexibility with respect to the platforms and operating systems of equipment that creates, edits and uses the bookmarks and bookmarked content, and with respect to the types of programs and tools that are used by the bookmark user's terminal equipment to process the bookmarked content.

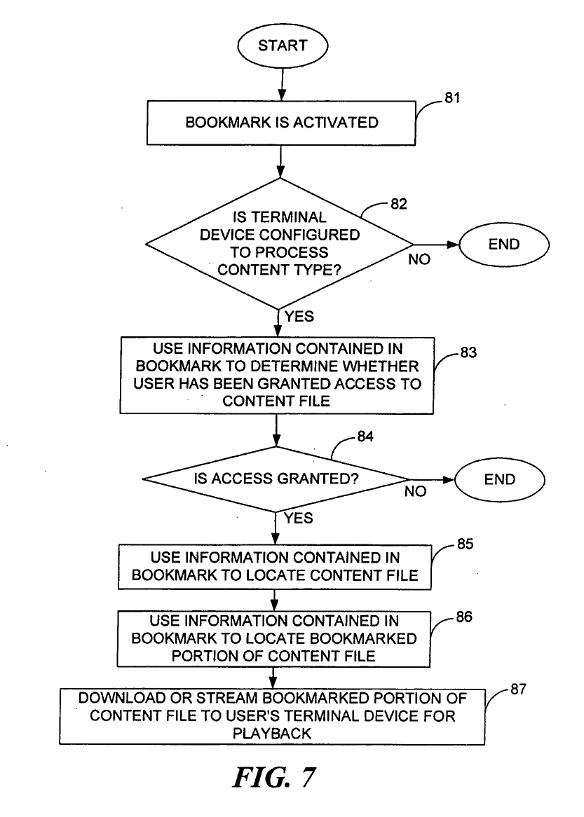

FIG. 7 illustrates a flowchart that demonstrates activation of the bookmark and the processes that occur following activation of the bookmark in a dynamically-enabled DRM system. When Customer C's terminal device activates the bookmark, as indicated by block 81, the terminal device analyzes the content type identified in the bookmark to determine if it can handle the content type, as indicated by block 82. The terminal device may also analyze the bookmark filename to verify that the device is able to handle the bookmarked file content. If the terminal device is not configured to process the identified content type, the program ends.

If the terminal device is configured to process the identified content type, then information contained in the bookmark, or appended to the bookmark, is analyzed to determine whether the user has been granted access to the content file, as indicated by block 83. This typically involves determining whether the user is listed on the BALL. A determination is made at block 84 as to whether the user is granted access. If not, the decoding program ends. The decoding program may cause the terminal device to notify the user that the user has not been granted access to the file, and/or to notify the user as to how the user can obtain access (e.g., by purchasing the digital rights to music referenced by the bookmark).

If a determination is made at block 84 that access has been granted to the user, the terminal device uses one or more of the following information fields contained in the bookmark (Table 1) to locate the content file: filename, content domain, content creation date, content owner, content last edit date, and content last edit owner. This step is represented in FIG. 7 by block 85. When the device locates the specific bookmarked file, the device scans the content file and locates the content location bookmark start mark. This step is represented in FIG. 7 by block 86. The bookmarked portion of the content file is then downloaded or streamed to the user's terminal device, as indicated by block 87.

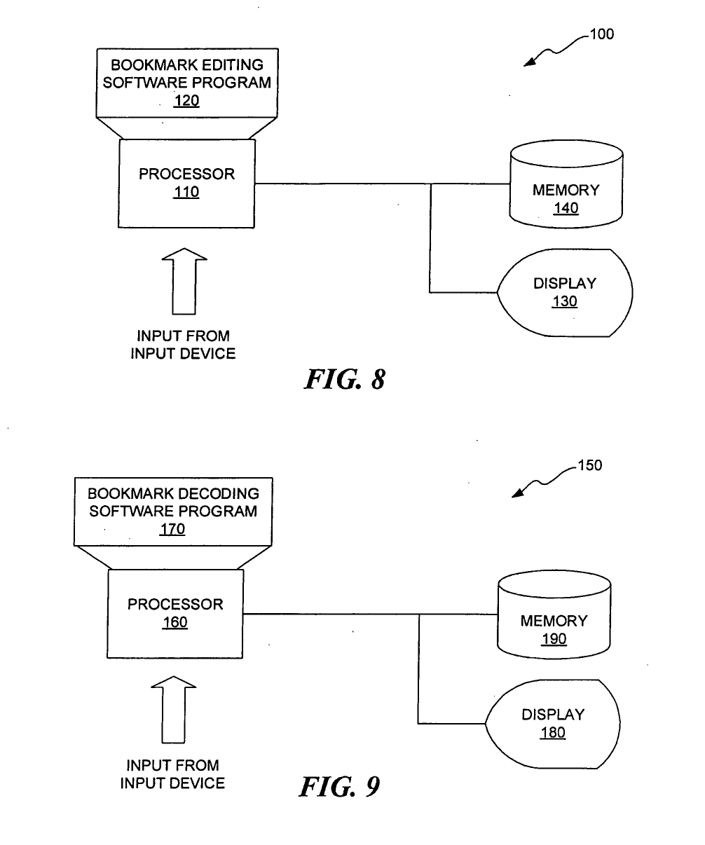

FIG. 8 illustrates the apparatus 100 of the invention for constructing the electronic bookmark. A processor 110 of the apparatus 100 is configured to execute a bookmark editing software program 120 that uses input received by the processor 110 from one or more user input devices (not shown) to construct the bookmark. The apparatus 100 may include a memory device 140 for storing the bookmark editing program 120 and other programs and data. The apparatus 100 may also include a display device 130, which the user may use to display information when creating and/or editing the bookmark.

FIG. 9 illustrates the apparatus 150 of the invention for activating and using the electronic bookmark. A processor 160 of the apparatus 150 is configured to execute a bookmark decoding software program 170 that decodes and activates an electronic bookmark. As described above, when the bookmark is, decoded and activated, this causes other software programs (e.g., a browser program, a media player program, etc.) to be executed. The processor 160 executes the decoding program 170 and these other programs (not shown) to cause the bookmarked portion of the content file to be downloaded or streamed to the apparatus 150.

The apparatus 150 may include a memory device 190 for storing the bookmark decoding program 170 and other programs and data. The apparatus 150 may also include a display device 150, which the user may use to display information when activating the bookmark. The processor 160 may also be programmed to execute a bookmark editing program to allow the user of the apparatus 150 to create and/or edit a bookmark.

The processors 110 and 160 may be any type of computational devices including, for example, microprocessors, application specific integrated circuits (ASICs), microcontrollers, programmable logic arrays, etc. Also, although the bookmark editing and decoding have been described as being performed in software, the processor may instead be hardware configured to execute one or both of the editing and decoding algorithms. The bookmarks and the bookmark editing and decoding programs may be stored in any type of computer-readable medium including, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses bookmarks and bookmark editing and decoding computer code in the form of electrical signals modulated on wired and wireless carriers (e.g., electrical conductors, wireless carrier waves, etc.) in packets and in non-packet formats.

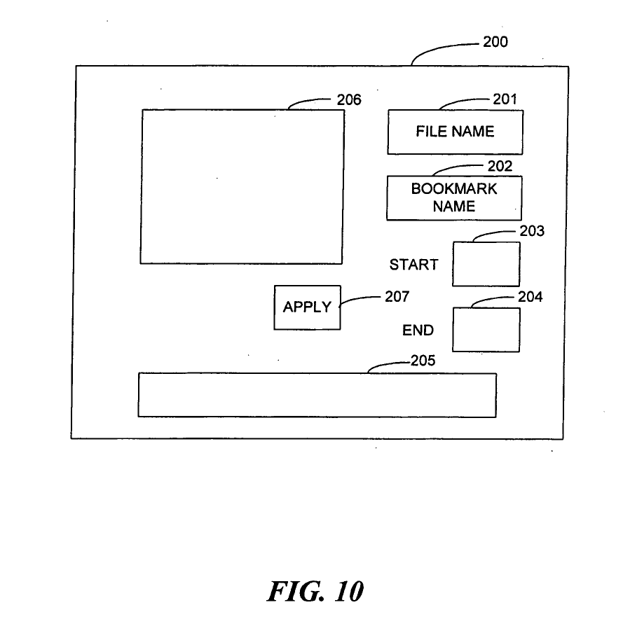

FIG. 10 illustrates an example of a GUI 200 that the bookmark editing program 10 shown in FIG. 1 presents to a user to facilitate creation and/or editing of a bookmark by the user. The GUI 200 includes a box 201 in which the user enters the file name of the content file, a box 202 in which the user enters the name of the bookmark, a box 203 in which the user enters the bookmark start location, and a box 204 in which the user enters the bookmark end location. The GUI 200 may include a box 205 that displays the locations of the start and end marks of the bookmark relative to the beginning and end of the content file. This will allow the user to view the locations of the start and end marks within the content file as the user applies the bookmark. The GUI 200 may also contain a box 206 that displays the content file, or a portion of it, so that the user can ascertain where to locate the start and end marks of the bookmark within the content file. For example, a clip from a movie may be played in box 206 to allow the user to determine where to locate the start and end marks of the bookmark. The GUI 200 may also contain an apply button 207 that the user clicks to cause the bookmark to be applied.

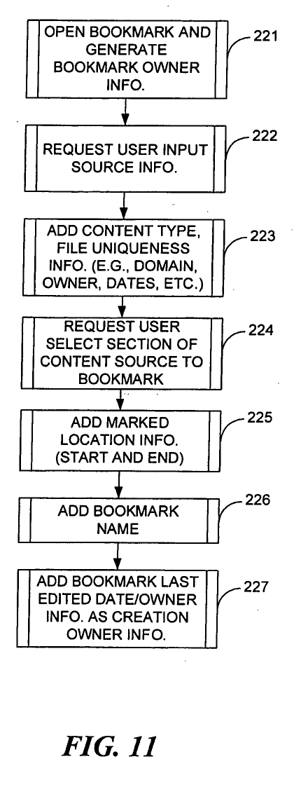

FIG. 11 illustrates a flowchart that demonstrates a method for creating a bookmark in accordance with an exemplary embodiment. Block 221 represents instantiation of the bookmark in memory by the bookmark editing program 10. In this example, the program 10 automatically applies the name of whoever is creating the bookmark, i.e., the domain of the bookmark creation owner. The program 10 then request, via a user interface such as that shown in FIG. 10, that the user input content source information, as indicated by block 222. This information may include, for example, the content file source domain, the content file creation date, the content file creation owner, etc. The program 10 then adds this content source information is then added to the bookmark along with other information such as, for example, the content file type, as indicated by block 223.

The program 10 may then request, via a user interface such as that shown in FIG. 10, that the user select the section of the content file that is to be bookmarked, i.e., the start and end marks, as indicated by block 224. After the user has entered this information, the program 10 adds this information to the bookmark, as indicated by block 225. The program 10 then adds the bookmark name to the bookmark, as indicated by block 226. The bookmark name may be either input by the user or automatically assigned by the program 10 based on the information input and/or generated during the steps represented by one or more of blocks 221-225. For example, the program 10 may assign a bookmark name that includes the file name, the bookmark creation owner's domain and the bookmark creation date. The bookmark is then applied, which corresponds to block 227. Application of the bookmark causes it to be saved in memory along with the date that the bookmark was last edited and the domain of the person who last edited the bookmark.

It should be noted that the steps represented by blocks 221-227 need not be performed in the order depicted. In addition, some of the steps are optional or preferred. Also, the process represented by FIG. 11 assumes that at least some of the information that is included in the bookmark is automatically generated or otherwise obtained by the program 10, which is not necessarily the case. This is to make the process of creating the bookmark efficient. However, all of the information that defines the bookmark may be supplied by the person creating the bookmark.

It should be noted that the invention has been described with reference to preferred and exemplary embodiments and that the invention is not limited to the embodiments described herein. Those skilled in the art will understand, in view of the description provided herein, that modifications can be made to the embodiments described herein and that all such modifications are within the scope of the invention.

What is claimed is:

1. A method for creating an electronic bookmark, the method comprising:
receiving user information describing information to be included in an electronic bookmark; and
constructing the bookmark in accordance with the received user information to include at least information identifying a content file location, a content file name, a content location bookmark start mark, and a content location bookmark end mark, the content file location identifying a location where a content file is stored, the content file name identifying a name of the content file, the content location bookmark start mark identifying a start location in the content file, the content location bookmark end mark identifying an end location in the content file.

2. The method of claim 1, wherein the bookmark further includes information identifying a type of content of the content file.

3. The method of claim 1, wherein the type of content of the content file is one of an audio/video (A/V) file, an audio file, a video file, a text file and an image file.

4. The method of claim 2, wherein the bookmark further includes information identifying users who have access to the bookmark.

5. The method of claim 2, wherein the bookmark further includes information identifying users who have access to the content file.

6. The method of claim 1, further comprising:
rendering content identified by the content location bookmark start mark and the content location bookmark end mark.

7. The method of claim 1, further comprising:
saving content identified by the content location bookmark start mark and the content location bookmark end mark.

8. The method of claim 1, further comprising:
transmitting the bookmark without the content file.

9. A method for using an electronic bookmark comprising:
receiving an electronic bookmark;
decoding the electronic bookmark in a user device, the decoded electronic bookmark at least including information identifying a content file location, a content file name, a content location bookmark start mark, and a content location bookmark end mark, the content file location identifying a location where a content file is stored, the content file name identifying a name of the content file, the content location bookmark start mark identifying a start location in the content file, the content location bookmark end mark identifying an end location in the content file; and
receiving a portion of the content file identified by the content location bookmark start mark and the content location bookmark end mark in the user device.

10. The method of claim 9, further comprising:
prior to receiving said portion of the content file, sending a request that includes the bookmark to a device on which the content file resides.

11. The method of claim 9, further comprising:
rendering said portion of the content file on a rendering device.

12. The method of claim 11, wherein the bookmark further includes information identifying a type of content of the content file.

13. The method of claim 12, wherein the type of content of the content file is one of an audio/video (A/V) file, an audio file, a video file, a text file and an image file.

14. The method of claim 11, wherein the bookmark further includes information identifying users who have access to the bookmark.

15. The method of claim 11, wherein the bookmark further includes information identifying users who have access to the content file.

16. A computer program for creating an electronic bookmark, the program being embodied in a computer-readable medium and including instructions for execution by a computer, the program comprising:
instructions for receiving user information describing information to be included in an electronic bookmark; and
instructions for constructing the bookmark in accordance with the received user information to include at least information identifying a content file location, a content file name, a content location bookmark start mark, and a content location bookmark end mark, the content file location identifying a location where a content file is stored, the content file name identifying a name of the content file, the content location bookmark start mark identifying a start location in the content file, the content location bookmark end mark identifying an end location in the content file.

17. The computer program of claim 16, wherein the bookmark further includes information identifying a type of content of the content file.

18. The computer program of claim 16, wherein the type of content of the content file is one of an audio/video (A/V) file, an audio file, a video file, a text file and an image file.

19. The computer program of claim 17, wherein the bookmark further includes information identifying users who have access to the bookmark.

20. The computer program of claim 17, wherein the bookmark further includes information identifying users who have access to the content file.

21. The computer program of claim 16, further comprising:
rendering content identified by the content location bookmark start mark and the content location bookmark end mark.

22. The computer program of claim 16, further comprising:
saving content identified by the content location bookmark start mark and the content location bookmark end mark.

23. The computer program of claim 16, further comprising:
transmitting the bookmark without the content file.

24. A computer program for using an electronic bookmark, the program being embodied in a computer-readable medium and including instructions for execution by a computer, the program comprising:
instructions for receiving an electronic bookmark;
instructions for decoding the electronic bookmark in a user device, the decoded electronic bookmark at least including information identifying a content file location, a content file name, a content location bookmark start mark, and a content location bookmark end mark, the content file location identifying a location where a content file is stored, the content file name identifying a name of the content file, the content location bookmark start mark identifying a start location in the content file, the content location bookmark end mark identifying an end location in the content file; and
instructions for receiving a portion of the content file identified by the content location bookmark start mark and the content location bookmark end mark in the user device.

25. The computer program of claim 24, further comprising:
instructions for sending a request that includes the bookmark to a device on which the content file resides.

26. The computer program of claim 24, further comprising:
instructions for rendering said portion of the content file on a rendering device.

27. The computer program of claim 26, wherein the bookmark further includes information identifying a type of content of the content file.

28. The computer program of claim 27, wherein the type of content of the content file is one of an audio/video (A/V) file, an audio file, a video file, a text file and an image file.

29. The computer program of claim 26, wherein the bookmark further includes information identifying users who have access to the bookmark.

30. The computer program of claim 26, wherein the bookmark further includes information identifying users who have access to the content file.
